(19) United States
(12) Patent Application Publication
(10) Pub. No.: US 2019/0236924 A1
(43) Pub. Date: Aug. 1, 2019

(54) ELECTRONIC DEVICE, CONTROL METHOD, AND COMPUTER-READABLE NONVOLATILE STORAGE MEDIUM FOR STORING PROGRAM

(71) Applicants: KABUSHIKI KAISHA TOSHIBA, Tokyo (JP); Toshiba Client Solutions Co., LTD., Tokyo (JP)

(72) Inventor: Rinzo Iwamoto, Nishitama Tokyo (JP)

(21) Appl. No.: 16/036,239

(22) Filed: Jul. 16, 2018

(30) Foreign Application Priority Data
Jan. 31, 2018 (JP) 2018-014662

(51) Int. Cl. G08B 21/04

(52) U.S. Cl. CPC G08B 21/0446; G08B 21/0415

(57) ABSTRACT

According to one embodiment, an electronic device wearable by a worker includes at least one of a proximity sensor or a contact sensor, a motion sensor, a display, a wearing detector, an abnormality detector, a display controller, and a notification controller. The wearing detector determines whether the electronic device is worn by the worker, based on first data obtained by at least one of the proximity sensor or the contact sensor. The abnormality detector detects an abnormal action of the worker by analyzing second data obtained by the motion sensor when the electronic device is determined to be worn by the worker. The display controller causes the display to display the abnormal action. The notification controller notifies another device of the abnormal action.

### CROSS-REFERENCE TO RELATED APPLICATIONS

This application is based upon and claims the benefit of priority from Japanese Patent Application No. 2018-014662, filed Jan. 31, 2018, the entire contents of which are incorporated herein by reference.

### FIELD

Embodiments described herein relate generally to an electronic device, a control method, and a computer-readable nonvolatile storage medium for storing program for detecting an abnormal action of a worker and notifying the abnormal action.

### BACKGROUND

To ensure the safety of workers who work in hazardous places, such as maintenance sites and factory lines, work status of workers are remotely monitored and abnormalities occurring in the workers are promptly found. For example, there is a technology for detecting abnormality occurring in a worker by attaching a sensor to the worker (the sensor being capable of detecting the position, movement, and the like of the worker), and analyzing data obtained from the sensor.

In a remote monitoring system using such a technology, when abnormality is detected, the detection of abnormality is usually notified to a monitoring center or the like. However, if the notification is immediately performed, unnecessary notification is generated in a case of an erroneous detection. This reduces monitoring efficiency of the monitoring center.

An object to be solved by the present invention is to provide an electronic device, a control method, and a computer-readable nonvolatile storage medium for storing program for detecting abnormality of a worker and appropriately notifying the detection result.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram illustrating an example of a remote support system including an electronic device according to an embodiment;

FIG. 2 is a block diagram illustrating an example of an operator terminal 12 in FIG. 1;

FIG. 3 illustrates an example of an appearance of a wearable device 23 connected to a mobile PC 16 in FIG. 1;

FIG. 4 illustrates an example of an appearance of a main body 24 of the wearable device 23;

FIG. 5 illustrates an example of connection between the mobile PC 16 and the wearable device main body 24;

FIG. 6 is a block diagram illustrating an example of the wearable device main body 24;

FIG. 7 illustrates an example of an appearance of the mobile PC 16;

FIG. 8 is a block diagram illustrating an example of the mobile PC 16;

FIG. 9 is a block diagram illustrating an example of processors included in the mobile PC 16 and the wearable device main body 24 according to a first embodiment;

FIG. 10 is a flowchart illustrating an example of automatic notification processing according to the first embodiment;

FIG. 11 is a flowchart illustrating an example of abnormal action detection processing according to the first embodiment;

FIG. 12 is a diagram illustrating an example of a display screen at the time of detecting an abnormal action according to the first embodiment;

FIG. 13 is a block diagram illustrating an example of processors included in a mobile PC 16 and a wearable device main body 24 according to a second embodiment;

FIG. 14 is a flowchart illustrating an example of periodic monitoring processing according to the second embodiment; and

FIG. 15 is a diagram illustrating an example of a display screen at the time of periodic monitoring according to the second embodiment.

### DETAILED DESCRIPTION

Various embodiments will be described hereinafter with reference to the accompanying drawings. Note that the disclosure is merely an example, and the invention is not limited by the content described in the following embodiments. Naturally, modifications easily conceivable by those skilled in the art are included in the scope of the disclosure. To make the description clearer, the size, shape, and the like of each portion may be schematically illustrated by providing change to actual embodiments in the drawings. In the drawings, corresponding elements are denoted by the same reference numeral, and detailed description may be omitted.

In general, according to one embodiment, an electronic device wearable by a worker includes at least one of a proximity sensor or a contact sensor, a motion sensor, a display, a wearing detector, an abnormality detector, a display controller, and a notification controller. The motion sensor detects a motion of the worker. The wearing detector determines whether the electronic device is worn by the worker, based on first data obtained by at least one of the proximity sensor or the contact sensor. The abnormality detector detects an abnormal action of the worker by analyzing second data obtained by the motion sensor when the electronic device is determined to be worn by the worker. The display controller causes the display to display the abnormal action. The notification controller notifies another device of the abnormal action when an operation is not received from the worker within a period of time after the display has displayed the abnormal action.

### First Embodiment

[Remote Support System]

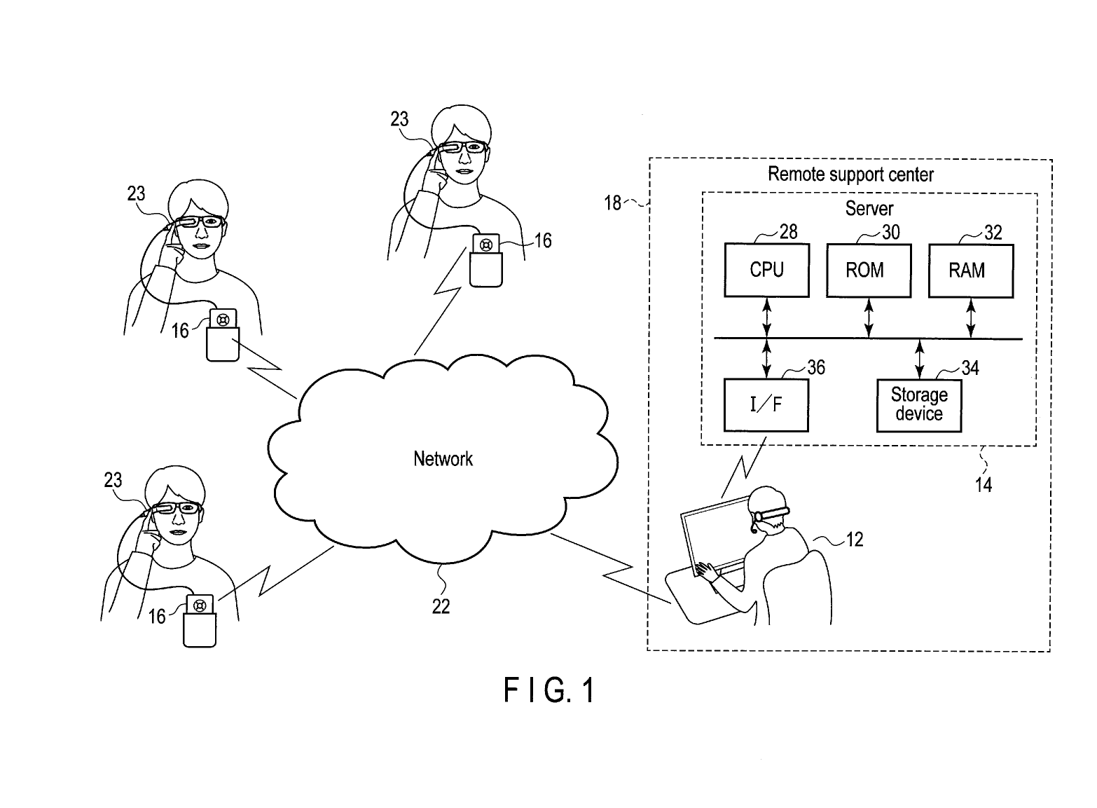

FIG. 1 is a block diagram illustrating an example of a remote support system for realizing edge computing. The remote support system is a system for supporting a user, for example, a worker at a work site from a remote place by a rear operator. Examples of on-site work include complicated maintenance work, picking work at a warehouse, field supervision, and disaster relief/medical support. The worker side of the work site is also referred to as front end, and the rear operator side is also referred to as back end. In the remote support system, a mobile personal computer (PC) (also referred to as mobile edge computing device) 16 carried by a worker and a remote support center (data center) 18 located at a distant position from the worker are connected via a network 22 and can communicate with each other. The mobile PC 16 and the remote support center 18 may be connected to the network 22 by a wired LAN cable or may be connected to the network 22 by a wireless LAN, Bluetooth (registered trademark), or the like.

A wearable device 23 is connected to the mobile PC 16. FIG. 1 illustrates an example in which the wearable device 23 is connected to the mobile PC 16 by a cable. However, the wearable device 23 may be connected to the mobile PC 16 by a wireless LAN, Bluetooth, or the like. The wearable device 23 includes a camera and a display, transmits an image captured by the camera to the mobile PC 16, and displays an image transmitted from the mobile PC 16 on the display.

As illustrated in FIG. 1, a plurality of workers can communicate with one another via the network. In this case, the workers can communicate through the remote support center 18, or the workers can communicate without through the operator of the remote support center 18.

The remote support center 18 includes an operator terminal 12 and a server 14. The remote support center 18 makes a voice call or exchanges information between the mobile PC 16 (and the wearable device 23) and the operator terminal 12. A real-time video of the wearable device 23 connected to the mobile PC 16 can be distributed to the operator terminal 12, and images can be transmitted and received to and from each other between the mobile PC 16 and the operator terminal 12. Further, a text message can be transmitted from the operator terminal 12 to the mobile PC 16. For example, in the picking work at a warehouse, the location of a picking item is displayed on the eyeglass-type wearable device 23 and hands-free picking can be realized.

Typically, the remote support includes, for example, the following functions.

(1) A voice call function to make a bidirectional voice call between the mobile PC 16 and the operator terminal 12.

(2) A live video distribution function to distribute a real-time video of the wearable device 23 to the operator terminal 12 during a voice call.

(3) A still image transmission/reception function to transmit/receive a still image between the mobile PC 16 and the operator terminal 12 during a voice call (the function to transmit, by the mobile PC 16, a captured still image or a capture image during video distribution to the operator terminal 12, and to write, by the operator terminal 12, characters and pictures on the received image and transmit the edited image to the mobile PC 16. The still image received by the mobile PC 16 is saved in a folder in the mobile PC 16 and can be browsed).

(4) A screen sharing function to display the entire desktop screen of the operator terminal 12 or a window of an arbitrary application program on the wearable device 23 during a voice call.

(5) A text message transmission function to transmit a text message from the operator terminal 12 to the mobile PC 16.

The server 14 performs processing for the remote support on behalf of or in cooperation with the operator terminal 12, and includes a processor (CPU) 28, a ROM 30, a RAM 32, a storage device 34 including a hard disk drive (HDD) or a solid state drive (SSD), and an interface 36. Note that all the functions of the server 14 may be provided to the operator terminal 12, and the server 14 may be omitted.

[Operator Terminal 12]

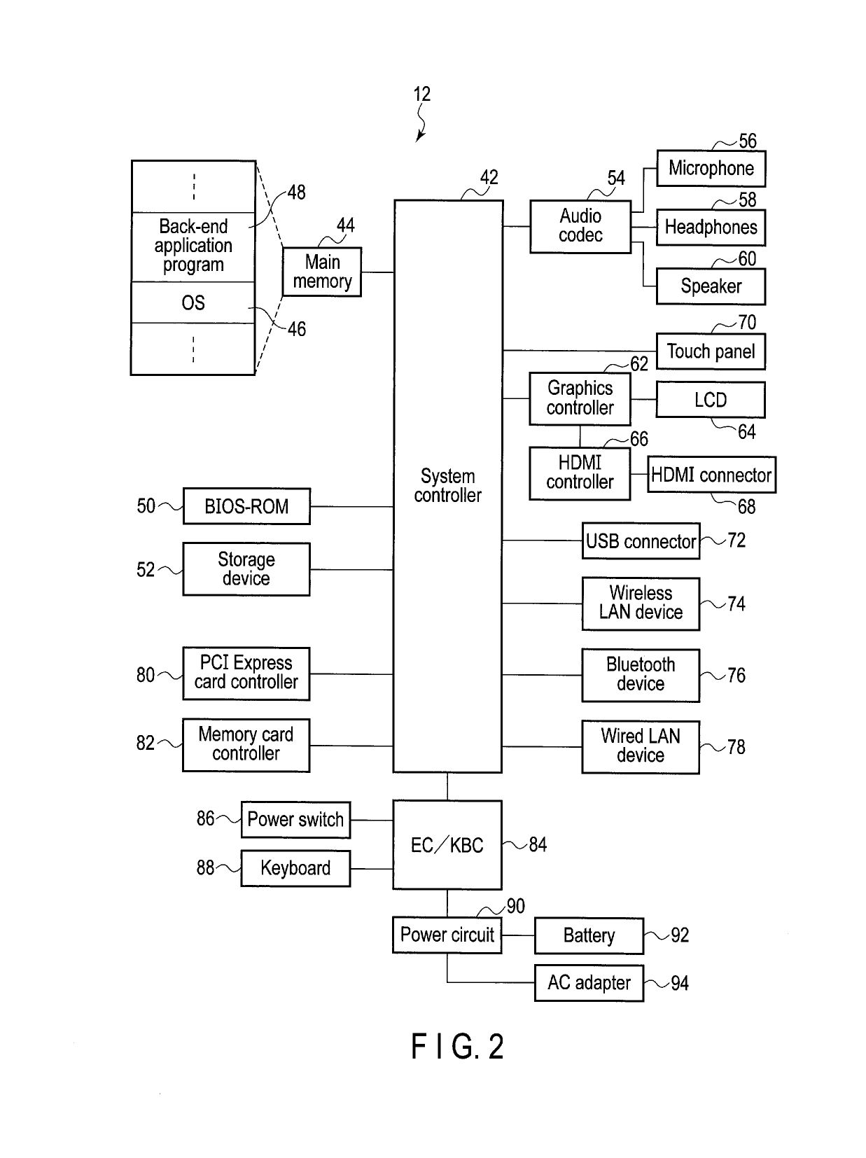

FIG. 2 is a block diagram illustrating an example of the operator terminal 12. The operator terminal 12 is a desktop-type PC, a notebook-type PC or the like.

The operator instructs the worker of the mobile PC 16 by a conversation or an image while confirming the situation of the work site on the real-time video using the operator terminal 12. The operator can write pictures and characters in an image file received from the mobile PC 16 using the operator terminal 12 and can transmit the edited image file to the mobile PC 16 or save the edited image file in the operator terminal 12.

The operator terminal 12 includes a system controller 42 including a processor. A main memory 44, a BIOS-ROM 50, a storage device 52 including an HDD or SSD, an audio codec 54, a graphics controller 62, a touch panel 70, a USB (registered trademark) connector 72, a wireless LAN device 74, a Bluetooth device 76, a wired LAN device 78, a PCI Express (registered trademark) card controller 80, a memory card controller 82, an embedded controller/keyboard controller (EC/KBC) 84, and the like are connected to the system controller 42.

The system controller 42 executes various programs loaded from the storage device 52 into the main memory 44. These programs include an operating system (OS) 46 and a back-end application program 48 for remote support. The system controller 42 also executes a basic input/output system (BIOS) stored in the BIOS-ROM 50 as a nonvolatile memory. The BIOS is a system program for hardware control.

The audio codec 54 converts a digital audio signal (to be played back) into an analog audio signal and supplies the analog audio signal to headphones 58 or a speaker 60. Further, the audio codec 54 converts an analog audio signal (input from the microphone 56) into a digital signal. The microphone 56 and the headphones 58 may be provided alone, or may be integrally provided as an intercom.

The graphics controller 62 controls a liquid crystal display (LCD) 64 used as a display monitor of the operator terminal 12. The touch panel 70 is overlaid on a screen of the LCD 64 so that a handwriting input operation can be performed on the screen of the LCD 64 with a touch pen or the like. An HDMI (registered trademark) controller 66 is also connected to the graphics controller 62. The HDMI controller 66 is connected to an HDMI connector 68 for connection with an external display device.

The wireless LAN device 74 executes IEEE 802.11 standard wireless LAN communication for connection with the network 22. The Bluetooth device 76 executes Bluetooth standard wireless communication for connection with an external device. The wired LAN device 78 executes IEEE 802.3 standard wired LAN communication for connection with the network 22. In this manner, the operator terminal 12 and the network 22 may be connected by wireless communication or wired communication.

The PCI Express card controller 80 performs PCI Express standard communication between the operator terminal 12 and an external device. The memory card controller 82 writes data to a storage medium, for example, a memory card such as an SD (Secure Digital) card (registered trademark), and reads data from the memory card.

The EC/KBC 84 is a power management controller and is realized as a one-chip microcomputer incorporating a keyboard controller for controlling a keyboard 88. The EC/KBC 84 has a function to power on or power off the operator terminal 12 in response to an operation of a power switch 86. The power-on and power-off control is executed by a cooperative operation of the EC/KBC 84 and a power circuit 90. The EC/KBC 84 is operated by power from a battery 92 or an AC adapter 94 even during a period in which the operator terminal 12 is powered off. The power circuit 90 generates power (to be supplied to each component) by using the power from the battery 92 or the power from the AC adapter 94 connected as an external power supply.

[Wearable Device 23]

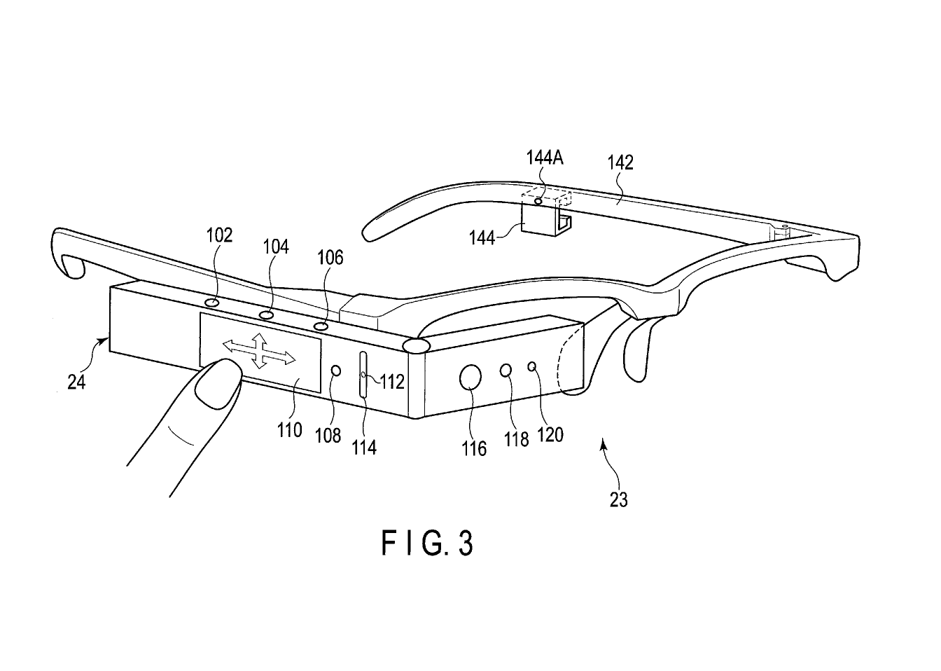

FIG. 3 illustrates an example of an appearance of the wearable device 23 connected to the mobile PC 16. The wearable device 23 includes an eyeglass frame 142 and a wearable device main body 24. The eyeglass frame 142 may have a shape of a typical eyeglass frame from which a lens is removed, and is attached to the face of the worker. The eyeglass frame 142 may have a structure to which eyeglasses can be attached. In the case where the worker always wears eyeglasses, a lens having similar power as the eyeglasses always worn by the worker may be attached to the eyeglass frame 142.

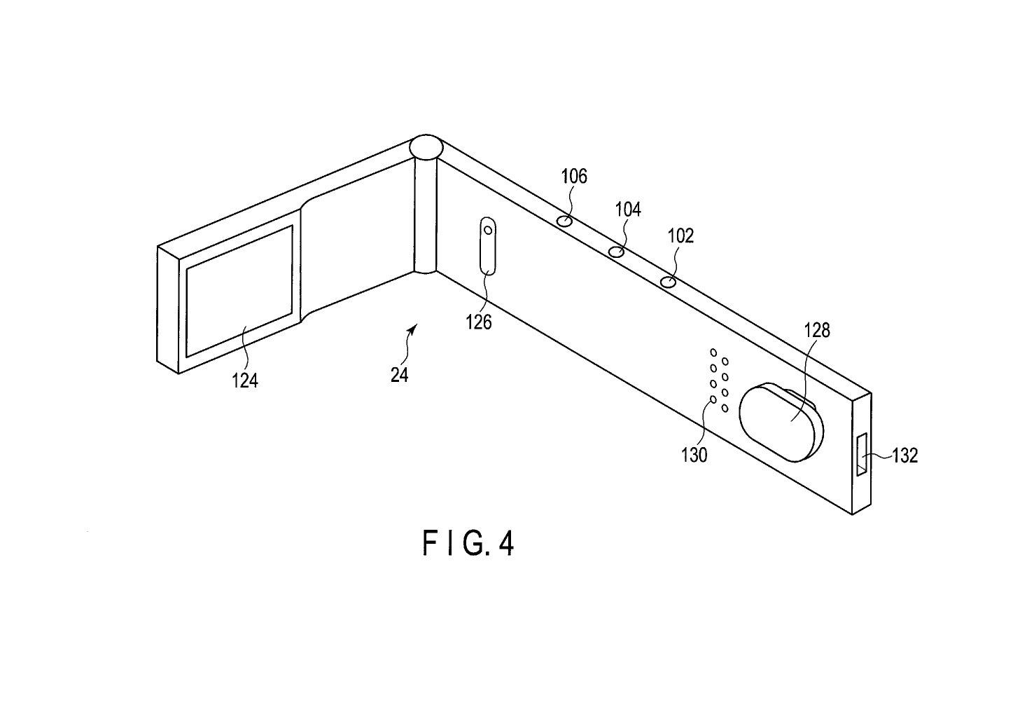

The eyeglass frame 142 includes fixtures 144, to and from which the wearable device main body 24 is attached and detached, on the right and left temples. In FIG. 3, the fixture 144 of the right-side temple of the worker is not illustrated because hidden by the wearable device main body 24. As described above, the wearable device main body 24 includes a display 124 (illustrated in FIG. 4), and the display 124 is viewed by one eye. Therefore, the fixtures 144 are provided on the right and left temples so that the wearable device main body 24 can be attached to the dominant eye side. The wearable device main body 24 does not need to be detachably attached to the eyeglass frame 142 with the fixtures 144, and the wearable devices 23 for right eye and left eye with the wearable device main body 24 fixed to the eyeglass frame 142 may be prepared. Further, the wearable device main body 24 may be attached to the worker's head, using a helmet, goggles or the like, instead of to the eyeglass frame 142.

The wearable device main body 24 is attached to the eyeglass frame 142 as an engagement piece 128 (illustrated in FIG. 4) is pushed into upper and lower frames of the fixture 144. When detaching the wearable device main body 24 from the eyeglass frame 142, the wearable device main body 24 is pulled out from the fixture 144.

The engagement piece 128 is slightly movable forward and backward within the fixture 144 with the wearable device main body 24 being attached to the fixture 144. Therefore, the front-rear position of the wearable device main body 24 can be adjusted so that the worker's eye can focus on the display 124. Further, the fixture 144 is rotatable about a shaft 144A orthogonal to the temple. After the wearable device main body 24 is attached to the eyeglass frame 142, the upper-lower position of the wearable device main body 24 can be adjusted so that the display 124 is positioned on the line of sight of the worker. Further, a rotation angle of the fixture 144 is about 90 degrees, and by turning the fixture 144 largely upward, the wearable device main body 24 can be flipped up from the eyeglass frame 142. Thereby, even in the case where the field of view is disturbed by the wearable device main body 24 and it is difficult to see a real object, or in the case where the wearable device main body 24 interferes with ambient objects in a narrow place, the wearable device main body 24 can be temporarily removed/returned from/to the field of vision of the worker without taking off/rewearing the entire wearable device 23 from/to the face.

[Wearable Device Main Body 24]

The wearable device main body 24 includes a side surface portion along the temple of the eyeglass frame 142 and a front surface portion positioned on the line of sight of one eyeball of the worker. The angle of the front surface portion with respect to the side surface portion can be adjusted.

As illustrated in FIG. 3, a camera 116, a light 118, and a camera LED 120 are provided on an outer surface of the front surface portion. The light 118 is an auxiliary light that emits light at the time of capturing a dark portion. The camera LED 120 lights up at the time of capturing a photograph or a moving image, and causes a person to be captured to recognize he or she is being captured.

First, second, and third buttons 102, 104, 106 are provided on tan upper side surface of the side surface portion of the wearable device main body 24 attached to the right-side temple. In the case where the dominant eye of the worker is the left eye, the wearable device main body 24 is attached to the left-side temple. The wearable device main body 24 is flipped upside down depending on whether the wearable device main body 24 is attached to the right side or the left side. Therefore, the first, second and third buttons 102, 104, and 106 may be provided on both the upper side surfaces and the lower side surface of the side surface portion.

A touch pad 110, a fourth button 108, a microphone 112, and an illuminance sensor 114 are provided on an outer surface of the side surface portion. The touch pad 110 and the fourth button 108 can be operated with the index finger. The buttons 102, 104, and 106 are arranged at positions where the buttons 102, 104, and 106 can be operated with the index finger, the middle finger, and the ring finger, respectively, when the wearable device main body 24 is attached to the right side. The touch pad 110 can detect movement of a finger up and down or front and back on the surface by the worker as illustrated by the arrows. Detection of the movement also includes drag movement to move the finger while keeping the finger in contact with the surface, and flick movement to quickly rub the finger against the surface. When detecting the up and down or front and back movement of the finger of the worker, the touch pad 110 inputs a command. In the present specification, the command is a command to execute specific processing for the wearable device main body 24. The methods of operating the first to fourth buttons 102, 104, 106 and 108, and the touch pad 110 are determined by an application program.

For example,

when the third button 106 is pressed once, an item is selected/an item is executed,

when the third button 106 is pressed and held for a long time, a list of active application programs is displayed,

when the second button 104 is pressed once, the screen is returned to a home screen,

when the second button 104 is pressed and held for a long time, a quick setting menu is displayed, and

when the first button 102 is pressed once, cancellation of the operation (similar operation to the Esc key on the keyboard) is executed.

As for the operation on the touch pad 110, for example,

when the touch pad is dragged up and down, a cursor is moved up and down,

when the touch pad is flicked forward, a left icon is selected (continuously scrolled),

when the touch pad is flicking backward, a right icon is selected (continuously scrolled),

when the touch pad is dragged forward, the left icon is selected (scrolled one item at a time), and

when the touch pad is dragged backward, the right icon is selected (scrolled one item at a time).

The first to fourth buttons 102, 104, 106, and 108 are arranged at positions where the first to fourth buttons 102, 104, 106, and 108 can be operated with the index finger, the middle finger, the ring finger, and the little finger, respectively. Note that the fourth button 108 being provided on the outer surface of the side surface portion rather than on the upper portion of the side surface portion is because of space limitations. The fourth button 108 may be provided on the upper surface of the side surface portion, similarly to the first to third buttons 102, 104, and 106. The illuminance sensor 114 detects ambient illuminance in order to automatically adjust the brightness of the display.

FIG. 4 illustrates an example of an appearance of a back side of the wearable device main body 24. The display 124 including an LCD is provided inside the front surface portion. A microphone 126, a speaker 130, and an engagement piece 128 are provided inside the side surface portion. The microphone 126 is provided in a front of the side surface portion, the speaker 130 is provided in a rear of the side surface portion, and the engagement piece 128 is provided in a rear of the side surface portion. A headphone may be used in place of the speaker 130. In that case, as with the operator terminal 12, the microphone and the headphone may be integrally provided as an intercom, similarly to the operator terminal 12.

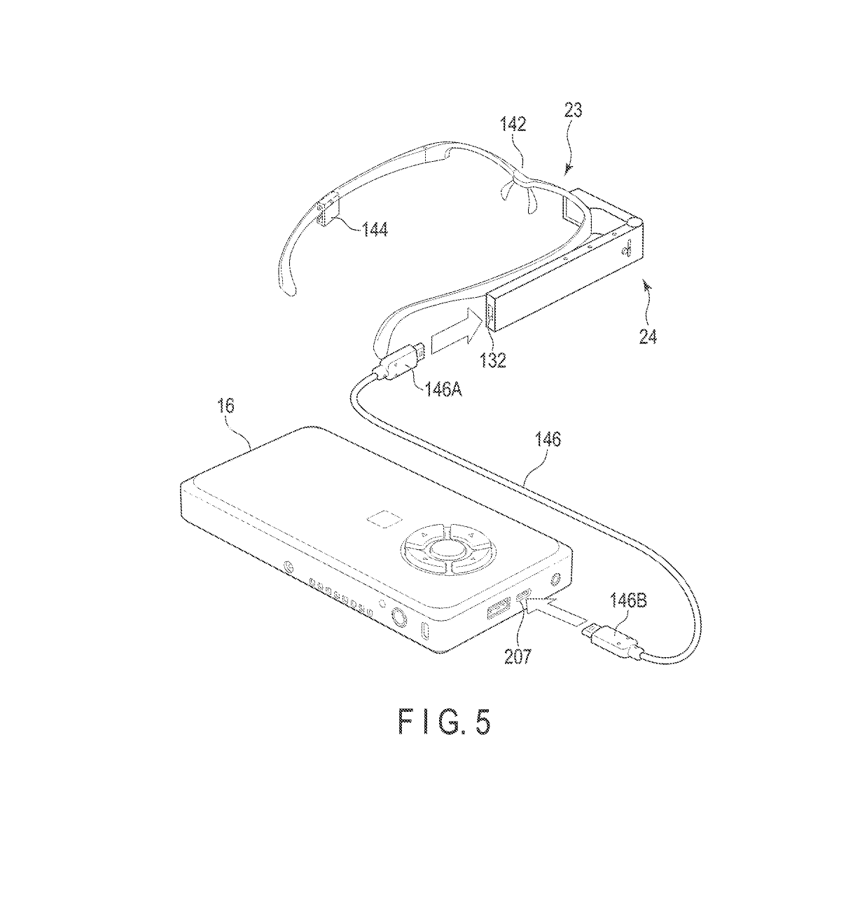

FIG. 5 illustrates an example of connection between the mobile PC 16 and the wearable device main body 24. A receptacle 132, into which a plug 146A of one end of the USB type-C (registered trademark) standard cable 146 is inserted, is provided in the rear of the side surface portion. A plug 146B of the other end of the USB type-C standard cable 146 is inserted into a USB type-C standard connector 207 on an upper end surface of the mobile PC 16. In this manner, the wearable device main body 24 is connected to the mobile PC 16 via the USB type-C standard cable 146, and an image signal and the like are transmitted between the wearable device main body 24 and the mobile PC 16. The wearable device main body 24 may be connected to the mobile PC 16 by wireless communication such as wireless LAN or Bluetooth.

In the embodiment, the wearable device main body 24 does not include a battery or a DC terminal as a drive power supply, and the drive power supply is supplied from the mobile PC 16 to the wearable device main body 24 via the USB type-C cable 146. However, the wearable device main body 24 may include a drive power supply.

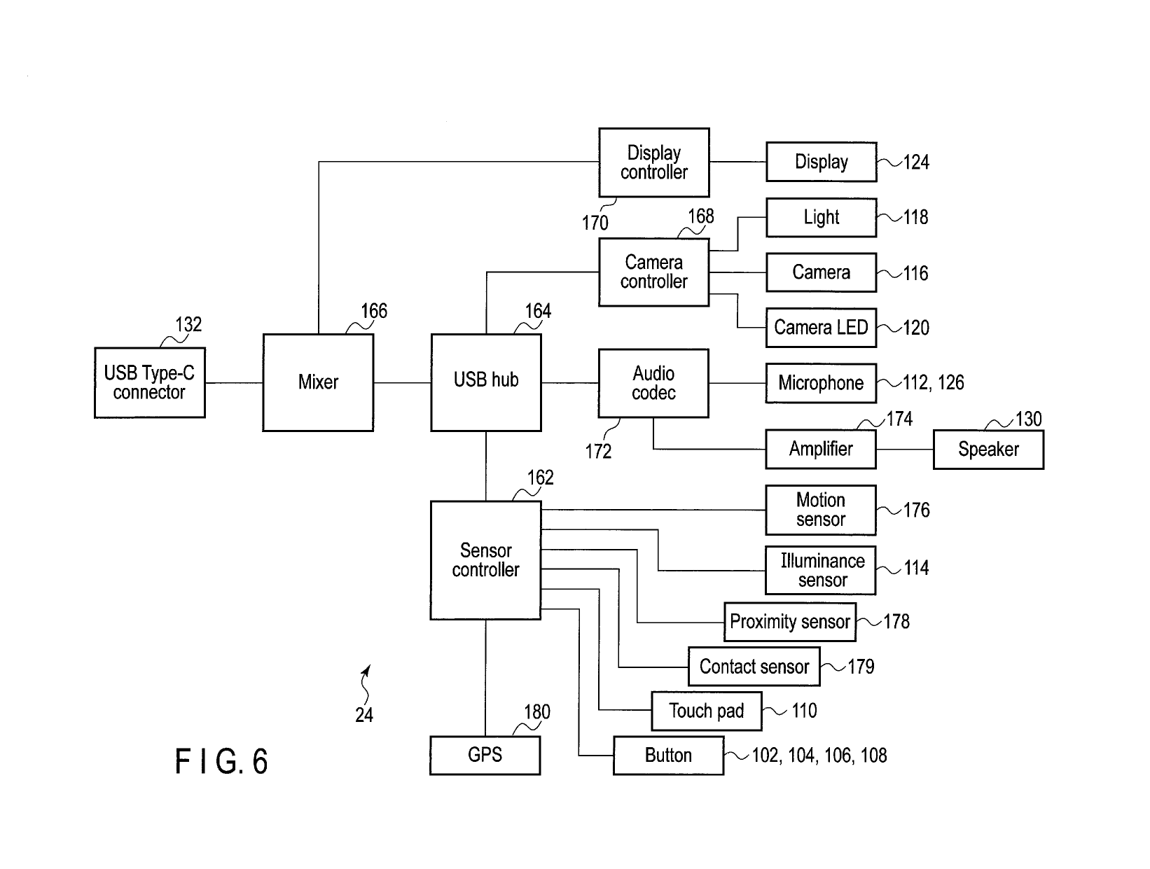

FIG. 6 is a block diagram illustrating an example of the wearable device main body 24. The USB type-C connector 132 is connected to a mixer 166. A display controller 170 and a USB hub 164 are connected to first and second terminals of the mixer 166. The display device 124 is connected to the display controller 170. A camera controller 168, an audio codec 172, and a sensor controller 162 are connected to a USB hub 164. The camera 116, the light 118 and the camera LED 120 are connected to the camera controller 168. Audio signals from the microphones 112 and 126 are input to the audio codec 172, and audio signals from the audio codec 172 are input to the speaker 130 via an amplifier 174.

A motion sensor (for example, acceleration/geomagnetic/gravity/gyro sensor) 176, the illuminance sensor 114, a proximity sensor 178, a contact sensor 179, the touch pad 110, the first to fourth buttons 102, 104, 106, 108, and a GPS sensor 180 are connected to the sensor controller 162. The sensor controller 162 processes detection signals from the motion sensor 176, the illuminance sensor 114, the proximity sensor 178, the contact sensor 179, the touch pad 110, the first to fourth buttons 102, 104, 106 and 108, and the GPS sensor 180, and supplies commands to the mobile PC 16. Although not illustrated in FIG. 4, the motion sensor 176 and the proximity sensor 178 are arranged inside the wearable device main body 24. The motion sensor 176 detects movement, orientation, posture, and the like of the wearable device main body 24. The proximity sensor 178 detects mount of the wearable device 23 by approach of the face, fingers, and the like of the worker. The contact sensor 179 is a mechanism capable of detecting a physical contact, and is, for example, a mechanical switch or a touch pad. The contact sensor 179 detects mount of the wearable device 23 by contact of the face, fingers, and the like of the worker, similarly to the proximity sensor 178. At least one of the proximity sensor 178 and the contact sensor 179 is provided.

[Mobile PC 16]

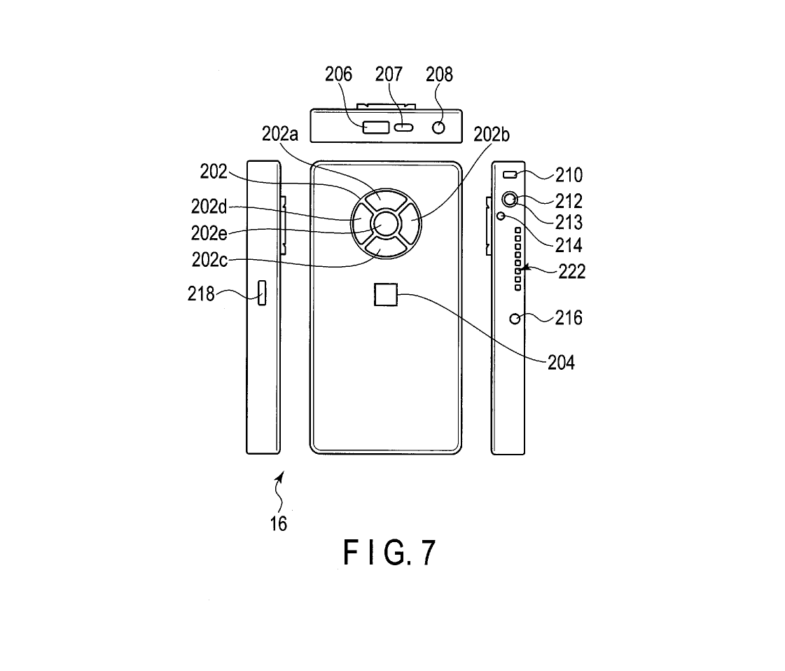

FIG. 7 illustrates an example of the appearance of a mobile PC (mobile edge computing device) 16. The mobile PC 16 is a small PC which can be held with one hand, and its size is about 10 cm or less in width, about 18 cm or less in height, and about 2 cm in thickness, and the weigh is about 300 g, which is small and light. Therefore, the mobile PC 16 can be housed in a pocket of work clothes, a holster attached to a belt, or a shoulder case, and is wearable. The mobile PC 16 houses a semiconductor chip such as a CPU and a semiconductor memory, and a storage device such as a solid state disk (SSD), but the mobile PC 16 does not include a display and a hardware keyboard for character input.

Five buttons 202 including an up button 202a, a right button 202b, a down button 202c, a left button 202d, a decision button (also referred to as center button or enter button) 202e are arranged on the front of the mobile PC 16, and a fingerprint sensor 204 is arranged below the five buttons 202. Since a hardware keyboard for character input is not provided and thus a password (also referred to as PIN) cannot be input, the fingerprint sensor 204 is used for user authentication at login of the mobile PC 16. The five buttons 202 can input commands.

Note that user authentication at login may be performed by assigning numbers to the buttons 202a to 202d of the five buttons 202 and by inputting a password using the five buttons 202. In this case, the fingerprint sensor 204 can be omitted. Since numbers are assigned to the four buttons except the decision button 202e, there are only four kinds of numbers. Therefore, there is a possibility that a randomly input number matches the password. However, if the number of digits of the password is increased, the probability that the randomly input number matches the password can be reduced. Even the mobile PC 16 including the fingerprint sensor 204 may adopt the authentication with the five buttons 202. One mobile PC 16 may be shared by a plurality of workers, but it is not possible to handle such a case only by the fingerprint authentication.

The same operation to the operation of the buttons 102, 104, 106 and 108, and the touch pad 110 of the wearable device main body 24 is possible for the five buttons 202. Since the worker cannot see the operation of the buttons 102, 104, 106 and 108, and the touch pad 110 of the wearable device main body 24, some workers may need to get accustomed to performing an intended operation. In addition, since the buttons 102, 104, 106 and 108, and the touch pad 110 are compact, operation may be difficult. In the embodiment, since the same operation can be performed with the five buttons 202 of the mobile PC 16, the above concern is solved. An operation method of the five buttons 202 is determined by the application.

For example,

when the decision button 202e is pressed once, selection of an item/execution of an item is performed (corresponding to one pressing of the third button 106 in the wearable device main body 24),

when the decision button 202e is pressed and held for a long time, termination or cancellation of an operation is performed (one pressing of the first button 102 corresponds to cancellation of an operation in the wearable device main body 24),

when the up button 202a is pressed once, the cursor is moved upward (corresponding to dragging upward on the touch pad 110 in the wearable device main body 24),

when the up button 202a is pressed and held for a long time, a list of active applications is displayed (corresponding to long pressing of the third button 106 in the wearable device main body 24),

when the down button 202c is pressed once, the cursor is moved downward (corresponding to dragging downward on the touch pad 110 in the wearable device main body 24),

when the down button 202c is pressed and held for a long time, a quick setting menu (described below) is displayed (corresponding to long pressing of the second button 104 in the wearable device main body 24),

when the left button 202d is pressed once, a right icon is selected (corresponding to dragging/flicking backward on the touch pad 110 in the wearable device main body 24), and

when the right button 202b is pressed once, a left icon is selected (corresponding to dragging/flicking forward on the touch pad 110 in the wearable device main body 24).

A USB 3.0 standard connector 206, a USB type-C standard connector 207, and an audio jack 208 are provided on an upper side surface of the mobile PC 16.

A card slot 218 for memory card is provided in one side surface (left-side side surface as viewed from the front) of the mobile PC 16. The memory card includes, for example, an SD card and a micro SD card (registered trademark).

A slot 210 for Kensington lock (registered trademark), a power switch 212, a power LED 213, a DC IN/battery LED 214, a DC terminal 216, a cooling ventilation hole 222 are provided in the other side surface (right-side side surface as viewed from the front) of the mobile PC 16. The power LED 213 is arranged in the vicinity of the power switch 212 and lights up during power on. The DC IN/battery LED 214 displays the state of the mobile PC 16, such as whether the battery is being charged, and the residual amount of the battery. Although the mobile PC 16 can be driven by a battery, the mobile PC 16 can also be driven with the AC adapter being connected to the DC terminal 216. Although not illustrated, the back surface is configured to enable battery replacement with a single touch.

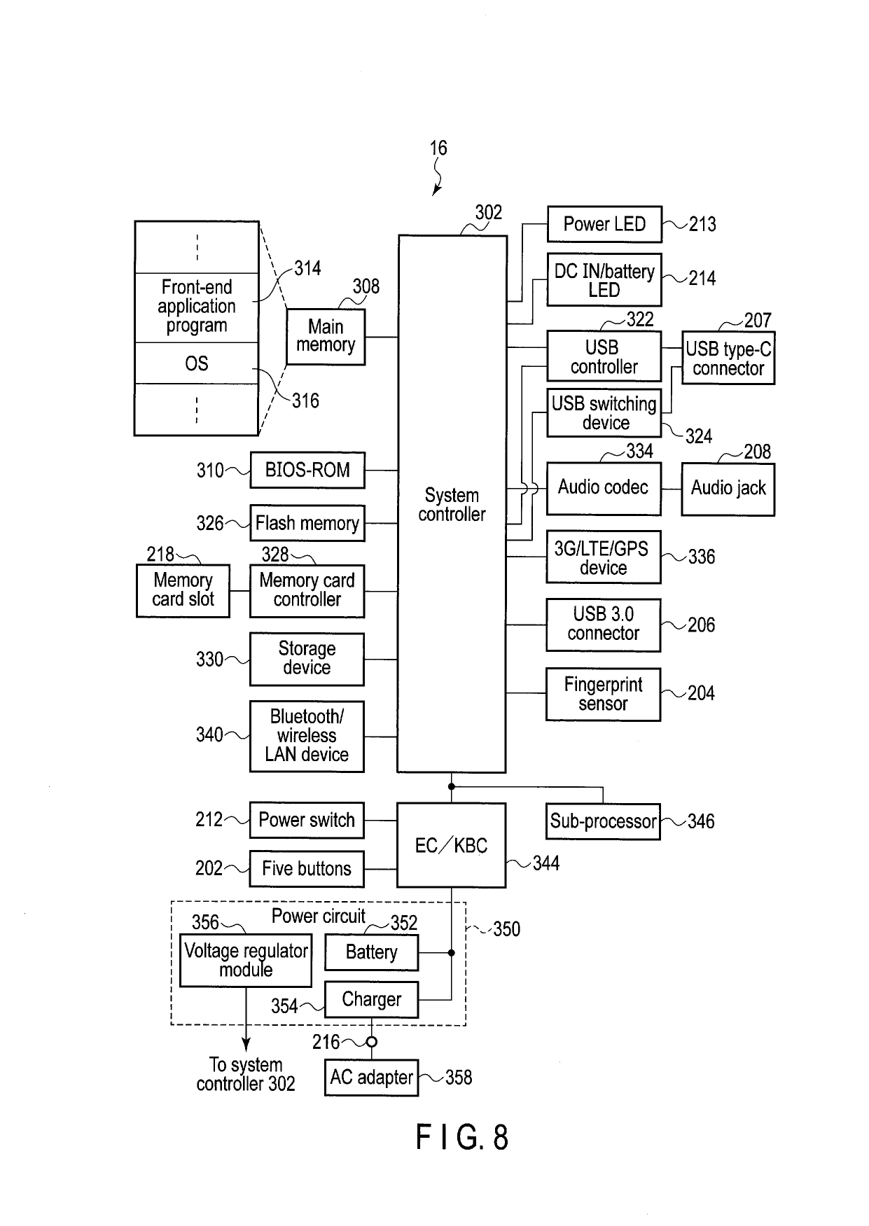

FIG. 8 is a block diagram illustrating an example of the mobile PC 16. The mobile PC 16 can distribute a video captured by the wearable device main body 24 to the operator terminal 12 and browse images received from the operator terminal 12. Therefore, the mobile PC 16 has a camera function and a viewer function. The camera function is a function to capture photographs and videos with the camera 116 of the wearable device main body 24. The captured photographs and videos are saved in a camera folder and can be viewed by the viewer function. The viewer function is a function to view files saved in the camera folder. Types of files include images, moving images, PDF files, photographs and videos captured by the camera function, images received from the operator terminal 12, images transmitted to the operator terminal 12, and files saved in a user folder.

The mobile PC 16 includes a system controller 302, and the system controller 302 includes a processor (CPU) and a controller hub. A main memory 308, a BIOS-ROM 310, a power LED 213, a DC IN/battery LED 214, and a USB controller 322 are connected to the processor. A flash memory 326, a memory card controller 328, a storage device 330 including an HDD or SSD, a USB switching device 324, an audio codec 334, a 3G/LTE/GPS device 336, a fingerprint sensor 204, a USB 3.0 connector 206, a Bluetooth/wireless LAN device 340, and an EC/KBC 344 are connected to the controller hub.

The system controller 302 executes various programs loaded from the storage device 330 into the main memory 308. These programs include an OS 316 and a front-end application program 314 for remote support.

The audio codec 334 converts a digital audio signal to be played back into an analog audio signal, and supplies the analog audio signal to the audio jack 208. Further, the audio codec 334 converts an analog audio signal input from the audio jack 208 into a digital signal.

The memory card controller 328 accesses a memory card, for example, an SD card inserted into the memory card slot 218, and controls reading/writing of data from/to the SD card.

The USB controller 322 controls transmission and reception of data to and from a USB type-C cable connected to the USB type-C connector 207 or a USB 3.0 cable (not illustrated) connected to the USB 3.0 connector 206.

Although not illustrated, a port expansion adapter can also be connected to the USB type-C connector 207, and an interface such as HDMI can be used.

The Bluetooth/wireless LAN device 340 executes Bluetooth standard wireless communication or IEEE 802.11 standard wireless LAN communication for connection with the network 22. Note that the connection with the network 22 is not limited to by the wireless communication and may be by IEEE 802.3 standard wired LAN communication.

The fingerprint sensor 204 is used for fingerprint authentication at the time of activation of the mobile PC 16.

A sub-processor 346, the power switch 212 and the five buttons 202 are connected to the EC/KBC 344. The EC/KBC 344 has a function to power on or power off the mobile PC 16 in response to an operation of the power switch 212. The power-on and power-off control is executed by a cooperative operation of the EC/KBC 344 and a power circuit 350. The EC/KBC 344 is operated by power from a battery 352 or an AC adapter 358 even during a period in which the mobile PC 16 is powered off. The power circuit 350 generates power (to be supplied to each component) by using the power from the battery 352 or the power from the AC adapter 358 connected as an external power supply. The power circuit 350 includes a voltage regulator module 356, and the voltage regulator module 356 is connected to a processor in the system controller 302.

Although the mobile PC 16 is configured as a separate body from the wearable device main body 24, the mobile PC 16 may be incorporated in the wearable device main body 24 to configure an integrated body.

[Automatic Notification Application Program]

Hereinafter, an automatic notification application program for detecting occurrence of an accident of the worker and notifying the accident to the remote support center 18, using the above-described remote support system, will be described.

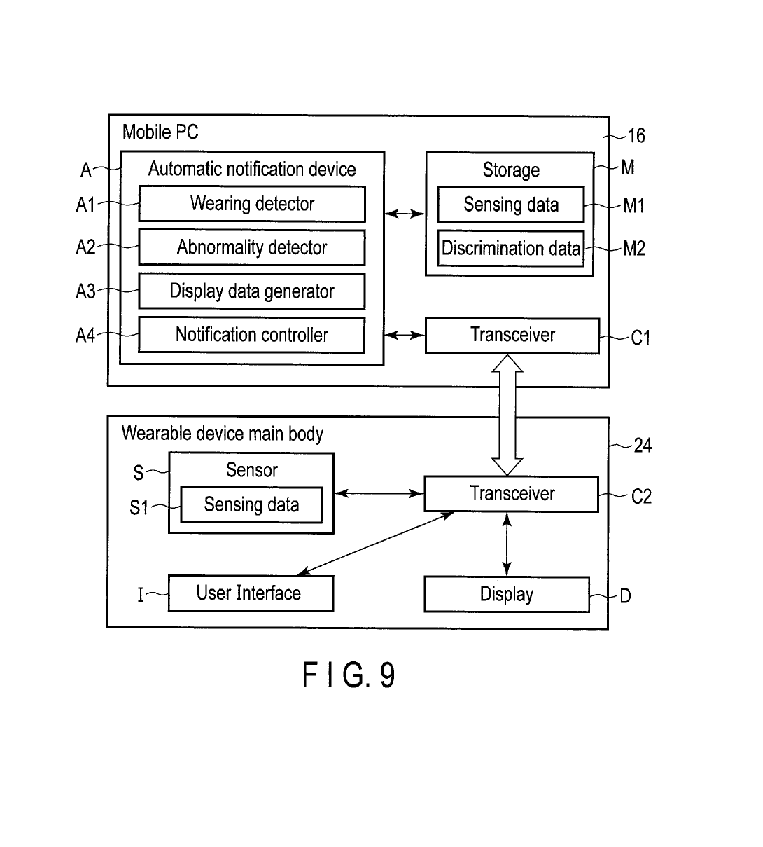

In FIG. 9, description will be given on the assumption that the wearable device main body 24 and the mobile PC 16 include processors described below for convenience. However, the wearable device main body 24 and the mobile PC 16 may respectively include processors, each having other functions, may be configured by one processor, or may include a plurality of processors in a mode other than that illustrated in FIG. 9. As described above, the wearable device main body 24 and the mobile PC 16 are electronic devices capable of processing various types of information.

The wearable device main body 24 includes a transceiver (a communication device) C2, a user interface (an input device) I, a display D, and a sensor S.

The transceiver C2 performs transmission and reception of data, commands, and the like to an external device, in this case, the mobile PC 16. The transceiver C2 includes, for example, the sensor controller 162, the USB hub 164, the USB type-C connector 132, and the like illustrated in FIG. 6. The transceiver C2 transmits data, commands, and the like generated by the wearable device main body 24 to the mobile PC 16, for example. Further, the transceiver C2 receives data required by each processor of the wearable device main body 24 from the external devices.

The user interface I receives an input from the worker who wears the wearable device 23. The user interface I includes, for example, the microphones 112 and 126, the touch pad 110, the buttons 102, 104, 106, 108, and the like.

The display D displays the display data received from the mobile PC 16 via the transceiver C2 in a visually recognizable manner by the worker. The display D includes, for example, the display 124.

The sensor S includes various sensors included in the wearable device main body 24. Specifically, the sensor S includes, for example, the motion sensor 176, the illuminance sensor 114, the proximity sensor 178, the contact sensor 179, the camera 116, the GPS sensor 180, and the like. The sensor S transmits sensing data S1 obtained by the above-described various sensors to the mobile PC 16 via the transceiver C2.

The mobile PC 16 includes, for example, the automatic notification application program, a storage M, and a transceiver (a communication device) C1.

The automatic notification application program is loaded from the system controller 302 illustrated in FIG. 8 into the main memory 308, thereby to be operated as an automatic notification device A. The automatic notification device A includes a wearing detector A1, an abnormality detector A2, a display data generator A3 (referred to as display controller in the claims), and a notification controller A4. Note that this automatic notification application program may be an application different from the front-end application 314 or may be included in the front-end application program 314.

The wearing detector A1 acquires the sensing data S1 obtained using the proximity sensor 178 and/or the contact sensor 179 of the sensor S via the transceiver C1. Further, the wearing detector A1 analyzes the acquired sensing data S1, and detects wearing of the wearable device 23 by, for example, detecting approach of the face, fingers, or the like of the worker.

The abnormality detector A2 detects an abnormal action of the worker, using the sensing data S1. The abnormal action is, for example, falling off from a high place, stillness for a long time, falling down, or the like. The abnormality detector A2 analyzes the sensing data S1, and detects the abnormal action by, for example, detecting a predetermined change pattern regarding the action of the worker.

The sensing data S1 may be stored and accumulated in the storage M. In the case where the sensing data S1 is stored in the storage M, the abnormality detector A2 may detect the abnormal action by a first or second detection method described below, using the past sensing data M1 accumulated in the storage M. To accumulate more useful sensing data M1, the abnormality detector A2 may store the sensing data S1 in the storage M when the wearable device 23 is determined to be worn by the wearing detector A1, for example. Further, the sensing data M1 may be accumulated in the storage device 52 or the like of the operator terminal 12 located at a remote place.

As the first detection method, the abnormality detector A2 generates a time change pattern (hereinafter, a standard pattern) of a standard sensor value indicating the abnormal action (or a safe action), for each type of the abnormal action (or the safe action), using the past sensing data M1. The abnormality detector A2 compares the sensing data S1 obtained from the wearable device main body 24 of the worker who is actually working, with the standard pattern generated in advance. For example, when a difference between the sensing data S1 and the standard pattern falls within a predetermined range, the abnormality detector A2 determines that the action of the worker is the abnormal action.

As the second detection method, the abnormality detector A2 may use a discriminator configured to discriminate the abnormal action (or the safe action). For example, the discriminator is configured using a neural network, a support vector machine (SVM) and the like, and learned beforehand using training data in which correct answers indicating whether the action is the abnormal action (or the safe action) is given to the past sensing data M1 (this training data is also teacher data). The abnormality detector A2 extracts a characteristic amount included in the sensing data S1 obtained from the wearable device main body 24 of the worker who is actually working, inputs the extracted characteristic amount to the discriminator, and obtains a probability indicating whether the action of the worker is the abnormal action (or the safe action) from the discriminator. Here, the characteristic amount indicates a numerical value of a characteristic included in the data. When the probability indicating that the abnormal action is high, the abnormality detector A2 determines that the action of the worker is the abnormal action. Note that the discriminator may be generated for each type of the abnormal action (or each type of the safe action).

The display data generator A3 generates data to be displayed on the display D of the wearable device main body 24. For example, the display data generator A3 can generate display data including various types of information relating to the user interface of the mobile PC 16 and work performed by the worker. The generated display data is displayed on the display D via the transceiver C1 and C2. In addition, in the present embodiment, the display data generator A3 generates display data for confirming the worker's abnormality when the abnormality detector A2 detects the abnormal action.

The notification controller A4 notifies the external device of the abnormality when the abnormality has occurred in the worker. More specifically, when the abnormality detector A2 detects the abnormal action of the worker, the notification controller A4 transmits a message or a signal indicating that the abnormality has occurred in the worker to the operator terminal 12 of the remote support center 18 or the like via the transceiver C1.

The transceiver C1 transmits and receives data, commands, and the like to and from the external devices, similarly to the transceiver C2. The transceiver C1 includes, for example, the USB type-C connector 207, the 3G/LTE/GPS device 336, the Bluetooth/wireless LAN device 340, the system controller 302, and the like. The transceiver C1 transmits data, commands, and the like generated by the application program A to the external devices such as the wearable device main body 24 and the operator terminal 12. Further, the transceiver C1 receives data required by each processor of the application program A from these external devices.

The storage M stores, for example, data, programs, and the like. The storage M includes, for example, the storage device 330, the flash memory 326, the memory card controller 328, and the like. The storage M stores data generated by the application program A and data acquired from the external device via the transceiver C1.

In the present embodiment, the storage M stores the sensing data M1 and discrimination data M2. The sensing data M1 is data of the accumulated sensing data S1 obtained from the sensor S, as described above. The discrimination data M2 is the standard pattern used in the first detection method described above, or the discriminator used in the second detection method, or the like. Note that the discrimination data M2 may include other data used in the abnormal action detection processing by the abnormality detector A2. Further, the discrimination data M2 is initialized with a predetermined initial value.

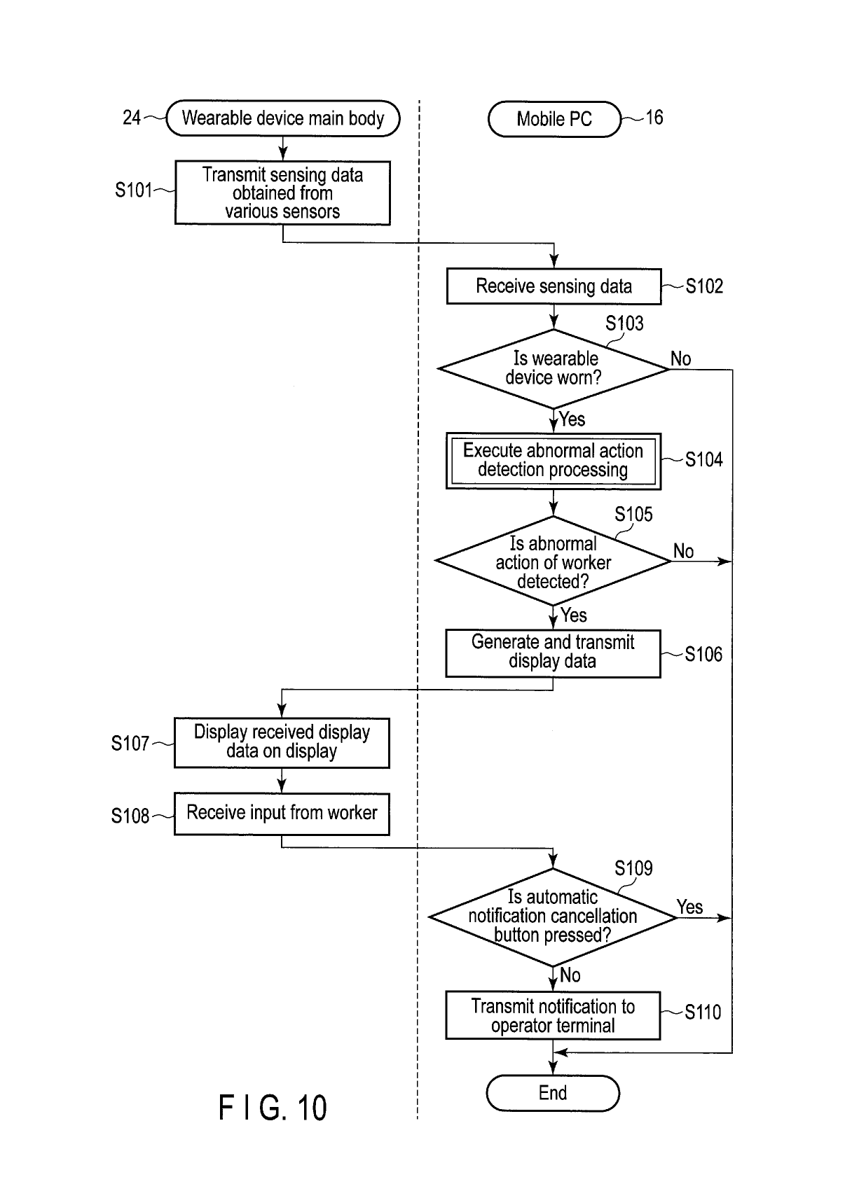

FIG. 10 is a flowchart illustrating an example of automatic notification processing executed by the automatic notification application program.

In step S101, the sensor S of the wearable device main body 24 acquires the sensing data S1 from the various sensors included in the sensor S. The sensing data S1 includes, for example, data indicating temporal changes of the position or acceleration of the worker (obtained by the motion sensor 176), and data indicating whether the worker is close to the wearable device main body 24 in time series manner (obtained by the proximity sensor 178 and/or the contact sensor 179), and the like. The sensor S transmits the acquired sensing data S1 to the mobile PC 16 via the transceiver C2.

In step S102, the application program A of the mobile PC 16 receives the sensing data S1 transmitted by the wearable device main body 24 via the transceiver C1, and stores the sensing data S1 in the storage M.

In step S103, the wearing detector A1 determines whether the worker is wearing the wearable device 23, using the sensing data S1 obtained by the proximity sensor 178 and/or the contact sensor 179, for example. When it is determined that the worker is not wearing the wearable device 23, the processing is terminated. On the other hand, when it is determined that the worker is wearing the wearable device 23, the processing proceeds to step S104.

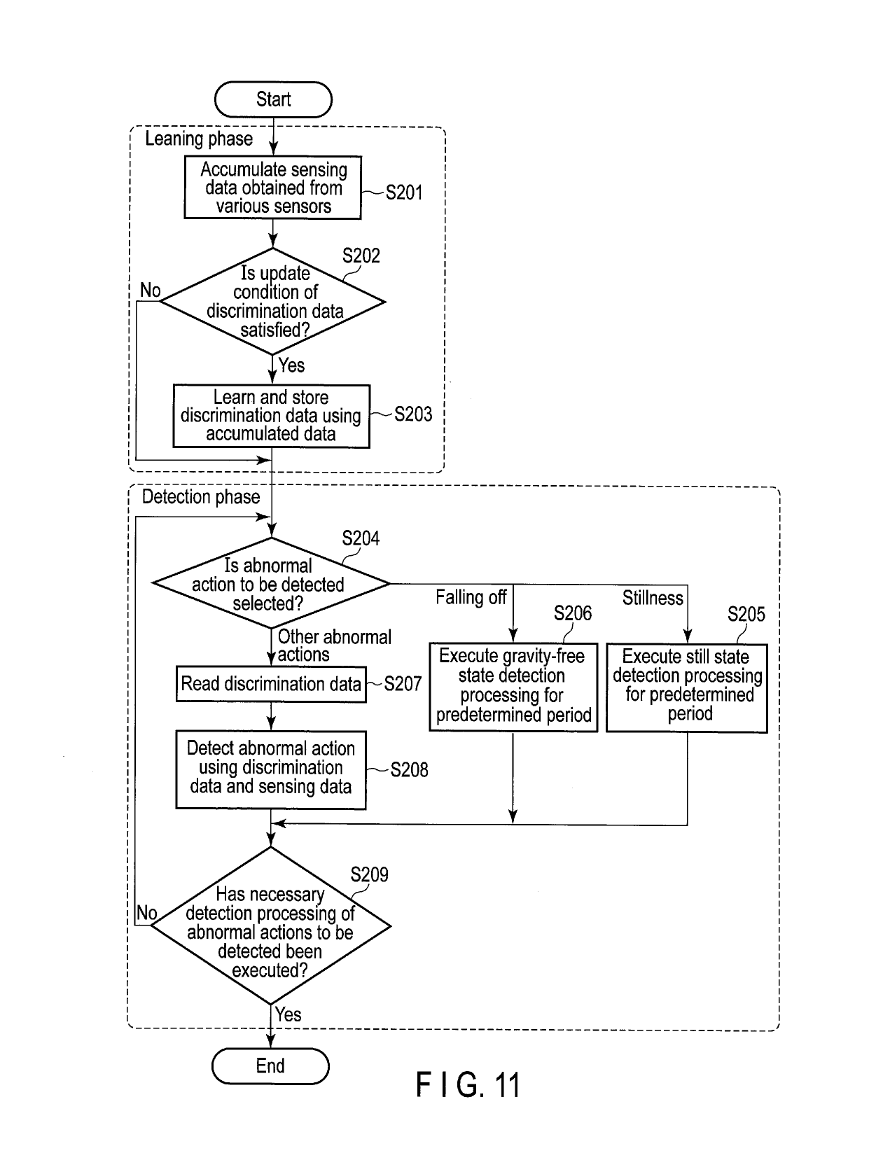

In step S104, the abnormality detector A2 executes abnormal action detection processing for the worker. Details of the detection processing will be described below with reference to FIG. 11.

In step S105, when the abnormal action of the worker is not detected by the abnormality detector A2, the processing is terminated. On the other hand, when the abnormal action is detected, the processing proceeds to step S106.

In step S106, the display data generator A3 generates the display data for displaying a message notifying the worker of the detection of the abnormal action and a message prompting the worker to reply, on the display D of the wearable device main body 24, and transmits the generated display data to the mobile PC 16 via the transceiver C1.

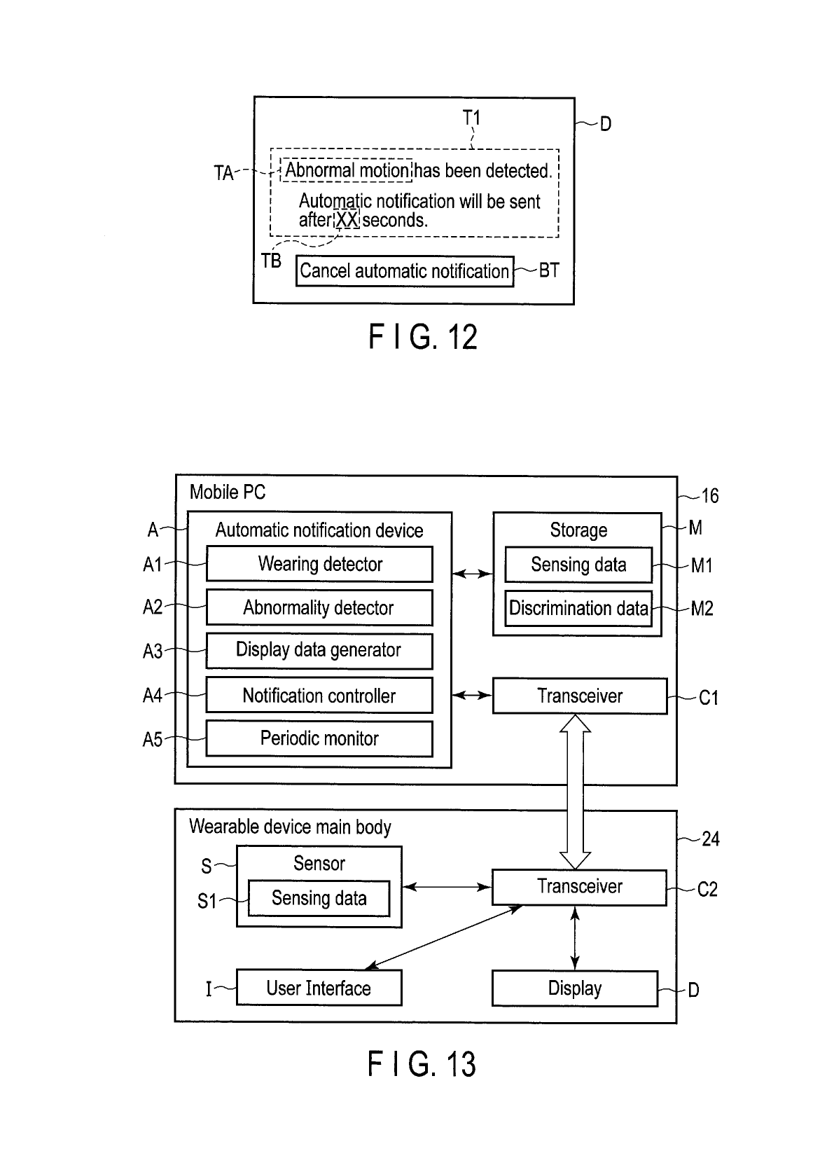

In step S107, the display D of the wearable device main body 24 receives the display data via the transceiver C2 and displays the display data thereon. Details of the display data will be described below with reference to FIGS. 12 and 13.

In step S108, the user interface I receives an input operation from the worker. The input operation is, for example, an operation to select and press an automatic notification cancellation button displayed on the display D based on the display data. When a predetermined input operation is performed, the user interface I transmits data concerning the input operation to the mobile PC 16 via the transceiver C2.

In step S109, the notification controller A4 determines whether the automatic notification cancellation button has been pressed based on the data concerning the input operation received via the transceiver C2. When the button is pressed within a predetermined time (a period of time), the processing is terminated. On the other hand, when the button is not pressed within the predetermined time, a possibility that the operator is not safe is considered. Therefore, in step S110, the notification controller A4 transmits a message, a signal, or the like notifying occurrence of abnormality in the worker to the operator terminal 12 and the like.

The above-described automatic notification processing is repeatedly executed every time new sensing data S1 is obtained, at sampling intervals of the various sensors, for example.

FIG. 11 is a flowchart illustrating an example of the abnormal action detection processing executed by the automatic notification application program. FIG. 11 corresponds to the processing of step S104 in FIG. 10.

Steps S201 to S203 are a learning phase that is a preparation stage for detecting the abnormal action. In step S201, the abnormality detector A2 receives the sensing data S1 obtained from the various sensors included in the sensor S via the transceiver C1, stores the sensing data S1 in the storage M, and accumulates the sensing data S1 as sensing data M1.

In step S202, whether an update condition of the discrimination data M2 is satisfied is determined. The update condition is, for example, obtainment of the sensing data M1 having a predetermined amount or more from a previous update time to a current moment, passage of a predetermined time from the previous update time to the current moment, and the like. When the update condition is satisfied, the processing proceeds to step S203. On the other hand, when the update condition is not satisfied, the processing proceeds to step S204.

In step S203, the abnormality detector A2 reads data (the sensing data obtained from the previous update time to the current moment) necessary for learning of the discrimination data M2 among the sensing data M1, from the storage M, and updates the discrimination data M2. The updated discrimination data M2 is stored in the storage M.

Steps S204 to S209 are a detection phase of the abnormal action. The abnormality detector A2 detects the abnormal action, by switching the abnormal action to be detected type by type. In the example of FIG. 11, it is assumed that the abnormal actions to be detected are “stillness”, “falling off”, and “other abnormal actions”. Note that the abnormality detector A2 does not need to detect all the abnormal actions described above, and may select the abnormal action to be detected according to the content of the work, for example.

In step S204, the abnormality detector A2 determines the type of the abnormal action to be detected.

In the case where the abnormal action to be detected is “stillness” of the worker, in step S205, the abnormality detector A2 detects whether the worker remains still for a long time, using the acquired sensing data S1. More specifically, the abnormality detector A2 determines that the worker remains still for a predetermined period when the position and the acceleration of the worker obtained by the motion sensor 176 are 0 (or values close to 0) in the predetermined period.

In the case where the abnormal action to be detected is “falling off” of the worker, in step S206, the abnormality detector A2 detects whether the worker is falling off, using the acquired sensing data S1. More specifically, the abnormality detector A2 determines that the worker is falling off when the position and the acceleration of the worker obtained by the motion sensor 176 indicate a gravity-free state (free fall).

Note that “stillness” and “falling off” illustrated in steps S205 and S206 can be determined by the predetermined change pattern of the sensing data S1 as described above, and thus the processing of steps S201 to S203, which is the learning phase, can be omitted.

In the case where the abnormal action to be detected is “other abnormal actions” of the worker, the abnormality detector A2 detects a predetermined abnormal action by the first detection method, the second detection method, or the like. Here, the “other abnormal actions” are, for example, a complicated action that is difficult to determine by extracting the predetermined change pattern from the sensing data S1, such as “falling down”, for example.

In step S207, the abnormality detector A2 reads the learned discrimination data M2 from the storage M in the learning phase. Further, in step S208, the abnormality detector A2 detects a predetermined abnormal action, using the read discrimination data M2 and the sensing data S1 acquired from the sensor S.

In step S209, the abnormality detector A2 confirms whether the detection processing for all the abnormal actions to be detected have been executed. When the detection processing for another abnormal action is to be performed, the processing returns to step S204.

FIG. 12 is a diagram illustrating an example of a display screen at the time of detecting the abnormal action. FIG. 12 illustrates the content displayed on the display D of the wearable device main body 24 in step S107 in FIG. 10.

In FIG. 12, the screen displayed on the display D includes a text T1 and a button BT. The text T1 is an example of texts for notifying the worker of detection of the abnormal action. The text T1 includes a text TA indicating the type of the abnormal action. For example, the text TA may be “long-term stillness”, “falling off”, “falling down” or the like. The text T1 also includes a text TB indicating a predetermined time (a period of time) during which the automatic notification can be canceled by the worker. This text TB may be displayed in a countdown form, for example.

The button BT is a button for canceling the automatic notification to the operator terminal 12. The worker can cancel the automatic notification by pressing the button BT within the predetermined time displayed on the text TB. Note that the worker may be able to cancel the automatic notification by performing another operation on the wearable device main body 24. For example, the notification controller A4 may cancel the automatic notification when detecting an input of a predetermined sound to the microphones 112 and 126 included in the user interface I of the wearable device main body 24, or when receiving a predetermined input to the touch pad 110, and the buttons 102, 104, 106 and 108.

According to the present embodiment described above, the wearable device main body 24 includes the sensor S, and transmits the sensing data S1 obtained from the various sensors of the wearable device main body 24 to the mobile PC 16 that is USB-connected to the wearable device main body 24. The mobile PC 16 includes the automatic notification application program, and the automatic notification application program analyzes the sensing data S1 to detect the abnormal action of the worker. With the configuration, since the acquired sensing data S1 can be analyzed without being transmitted to a terminal (for example, the operator terminal 12) located at a remote place from the wearable device main body 24, the real-time property of the analysis processing is improved. That is, even when the data amount of the sensing data S1 is large, or even when the analysis processing takes a long time, the analysis processing can be executed without impairing the real-time property.

In the present embodiment, the automatic notification application program generates the discrimination data M2 based on the sensing data M1 stored in the storage M, and detects the abnormal action based on the discrimination data M2. With the configuration, not only the relatively simple actions such as “falling off” and “long-time stillness” but also complicated actions such as “falling down”, which is difficult to discriminate by determination by logic, can be determined.

In addition, the discrimination data M2 is updated to the latest state when a predetermined condition associated with accumulation of the sensing data M1 is satisfied. As a result, detection accuracy of the abnormal action of the worker can be enhanced.

In the present embodiment, when detecting the abnormality of the worker, the automatic notification application program of the mobile PC 16 causes the wearable device main body 24 to display the button for cancellation of the automatic notification, together with the message notifying detection of the abnormal action. With the configuration, even when the abnormal action is erroneously detected, erroneous notification to the operator terminal 12 can be suppressed by cancellation of the automatic notification. Further, unnecessary safety confirmation of the worker by the operator terminal 12 that has received the erroneous notification can be suppressed. Therefore, the monitoring efficiency of the remote support center 18 can be improved, and the decrease in work efficiency of the worker can be suppressed.

### Second Embodiment

In the first embodiment, when the abnormal action is detected in step S107 in FIG. 10, the detection of the abnormal action is displayed on the display D of the wearable device main body 24. In addition to the above, it is better to conduct safety confirmation for the worker on a regular basis (for example, every one hour) even when no abnormal action is detected.

In the present embodiment, periodic monitoring processing performed by an automatic notification application program will be described. Configurations of an operator terminal 12 and a remote support center 18 are similar to those of the first embodiment, and therefore description thereof is omitted.

FIG. 13 is a block diagram illustrating an example of processors included in a mobile PC 16 and a wearable device main body 24 in the present embodiment.

Similarly to the first embodiment, the automatic notification application program is loaded from a system controller 302 illustrated in FIG. 8 into a main memory 308, thereby to be operated as an automatic notification device A. The automatic notification device A according to the present embodiment includes a periodic monitor A5 for performing periodic monitoring processing, in addition to a wearing detector A1, an abnormality detector A2, a display data generator A3, and a notification controller A4 described in the first embodiment.

The periodic monitor A5 includes, for example, a timer. The periodic monitor A5 requests the display data generator A3 to generate display data indicating that the safety confirmation is to be performed at predetermined time intervals. Note that the timer may be implemented by either software or hardware. Further, the periodic monitor A5 may be included in the display data generator A3.

A storage M and a transceiver C1 of the mobile PC 16, a transceiver C2, a user interface I, a display D, and a sensor S of the wearable device main body 24 are similar to those in the first embodiment, and thus description is omitted.

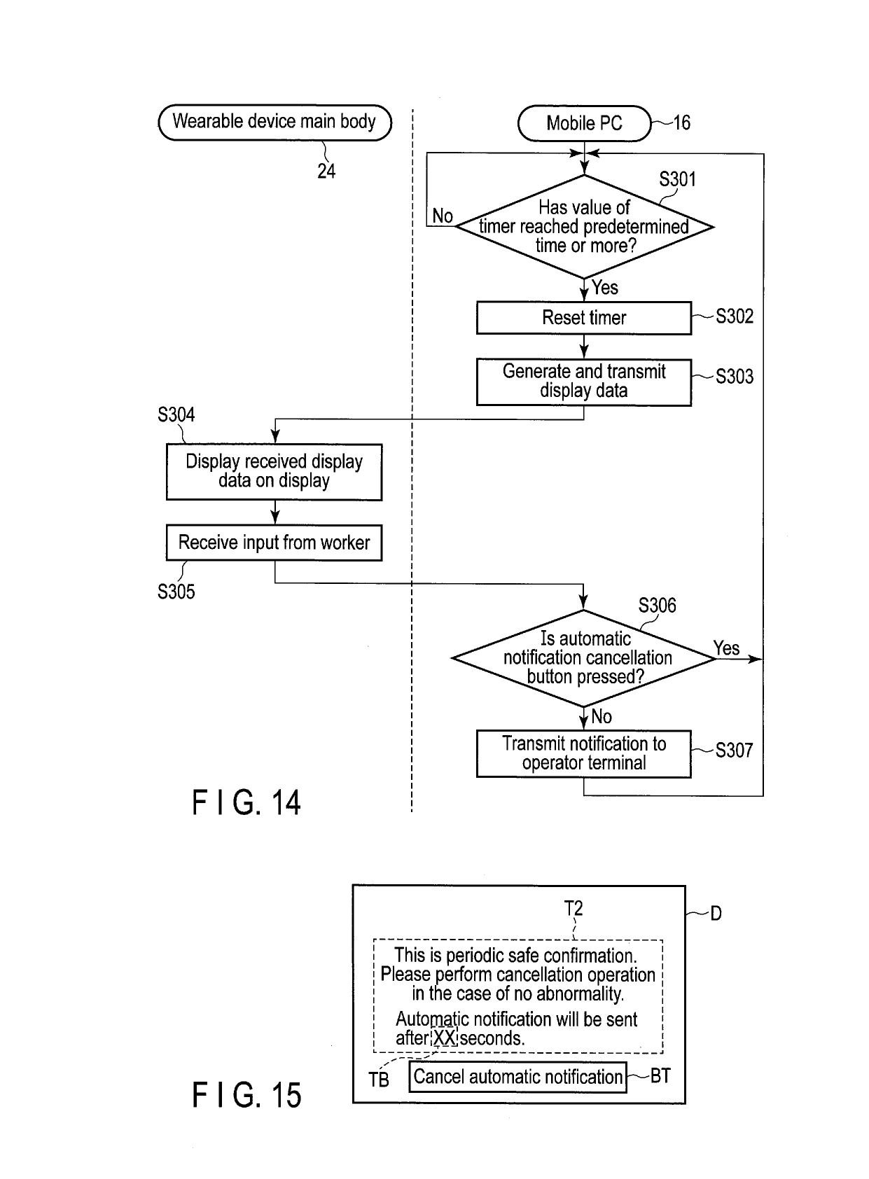

FIG. 14 is a flowchart illustrating an example of the periodic monitoring processing executed by the automatic notification application program.

In step S301, the periodic monitor A5 checks a value of the timer. The periodic monitor A5 checks whether the value of the timer has reached a predetermined time or more. The predetermined time is, for example, one hour. The periodic monitor A5 waits until the value of the timer reaches the predetermined time.

When the value of the timer has reached the predetermined time or more, the periodic monitor A5 resets the timer in step S302. Further, the periodic monitor A5 requests the display data generator A3 to generate display data to be used for periodic monitoring.

In step S303, the display data generator A3 generates display data for displaying a message notifying a worker that periodic safety confirmation is to be performed and a message prompting the worker to reply, on the display D of the wearable device main body 24, and transmits the generated display data to the mobile PC 16 via the transceiver C1.

Since processing of steps S304 to S307 is similar to the processing of steps S107 to S110 illustrated in FIG. 10, description thereof is omitted. After step S307, the processing returns to step S301 and is repeatedly executed.

FIG. 15 is a diagram illustrating an example of a display screen at the periodic monitoring. FIG. 15 illustrates the content displayed on the display D of the wearable device main body 24 in step S304 in FIG. 14.

In FIG. 15, the screen displayed on the display D includes a text T2 and a button BT. The text T2 is an example of texts for notifying the worker of the periodic safety confirmation. The text T2 includes a text TB. Functions and roles of the text TB and the button BT are equivalent to those in FIG. 12.

In the present embodiment described above, the automatic notification application program periodically performs the safety confirmation for the worker regardless of whether abnormality is detected. Therefore, even when the abnormal action is not detected although the worker has conducted the abnormal action, safety of the worker can be secured by functioning the periodic monitoring.

Note that the timing to conduct the periodic monitoring may be automatically adjusted in conjunction with the timing when the abnormal action has been detected. More specifically, the periodic monitor A5 may reset the timer, for example, when the abnormality detector A2 has detected the abnormal action. In addition, the periodic monitor A5 may change the interval (that is, the value of the above-described predetermined time) at which the periodic monitoring is performed, according to the frequency at which the abnormality detector A2 detects the abnormal action of the worker. For example, the periodic monitor A5 may increase the interval at which the periodic monitoring is to be performed when the frequency at which the abnormality detector A2 detects the abnormal action of the worker is low, while the periodic monitor A5 may decrease the interval at which the periodic monitoring is to be performed when the frequency at which the abnormality detector A2 detects the abnormal action of the worker is high.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A wearable electronic device comprising:
at least one of a proximity sensor or a contact sensor;
a motion sensor that detects a motion of the wearable electronic device that is worn by a user;
a display;
a wearing detector that determines whether the user wears the wearable electronic device, based on first data obtained by at least one of the proximity sensor or the contact sensor;
an abnormality detector that detects an abnormal action of the user by analyzing second data obtained by the motion sensor when the wearing detector determines that the user wears wearable electronic device;
a display controller that causes the display to display a prompt message when the abnormality detector detects the abnormal action; and
a notification controller that transmits a notification to another device when an input from the user is not received within a period of time after the display has displayed the prompt message.

2. The electronic device according to claim 1, wherein
the notification controller does not transmit the notification when the input is received from the user within the period of time after the display has displayed the prompt message.

3. The electronic device according to claim 1, further comprising:
a camera that captures image data; and
a storage that stores sensing data and discrimination data, the sensing data comprising a plurality of the first data obtained in a past, a plurality of the second data obtained in a past, and a plurality of the image data obtained in a past and the discrimination data for detecting the abnormal action,
wherein the abnormality detector generates the discrimination data using the sensing data, and stores the discrimination data into the storage.

4. The electronic device according to claim 3, wherein
the discrimination data comprises a time change pattern of a sensor value indicating the abnormal action, the time change pattern being a standard pattern of each type of the abnormal action; and
the abnormality detector detects the abnormal action by comparing the sensing data obtained at a current moment with the standard pattern of each type of the abnormal action.

5. The electronic device according to claim 3, wherein
the discrimination data is learned using teacher data as the abnormal action, and used as a discriminator; and
the abnormality detector extracts a characteristic amount from the sensing data obtained at a current moment, inputs the characteristic amount to the discriminator, and detects the abnormal action by obtaining a probability that the characteristic amount indicates the abnormal action from the discriminator.

6. The electronic device according to claim 3,
wherein the abnormality detector determines whether an update condition of the discrimination data is satisfied, extracts specific data from the sensing data stored in the storage when the update condition is satisfied, and updates the discrimination data with the specific data.

7. The electronic device according to claim 6,
wherein the update condition comprises at least one of obtainment of the sensing data having a predetermined amount or more from a previous update time to a current moment, or passage of a predetermined time from the previous update time to the current moment.

8. The electronic device according to claim 6,
wherein the specific data comprises the sensing data obtained from a previous update time to a current moment.

9. The electronic device according to claim 1,
wherein the abnormal action comprises falling off of the user, stillness of the user for a predetermined period of time or more, and falling down of the user.

10. The electronic device according to claim 1,
wherein the display controller causes the display to display data indicating that safety confirmation of the user is to be performed periodically.

11. The electronic device according to claim 1,
wherein the input comprises an indication for cancelling the notification by the notification controller.

12. The electronic device according to claim 11,
wherein the display controller causes the display to display a button for cancelling the notification by the notification controller.

13. The electronic device according to claim 1, further comprising:
a first electronic device comprising the motion sensor, the display, and at least one of the proximity sensor or the contact sensor; and
a second electronic device electrically connected to the first electronic device and comprising the wearing detector, the abnormality detector, and the notification controller.

14. The electronic device according to claim 13, wherein
the first electronic device is an eyeglass-type wearable device; and
the second electronic device is a portable personal computer.

15. A method of controlling a wearable electronic device comprising a motion sensor, a display, at least one of a proximity sensor or a contact sensor, the method comprising:
determining whether a user wears the wearable electronic device, based on first data obtained by at least one of the proximity sensor or the contact sensor;
detecting an abnormal action of the user by analyzing second data obtained by the motion sensor when it is determined that the user wears the wearable electronic device;
causing the display to display a prompt message when the abnormal action is detected; and
transmitting a notification to another device when an input from the user is not received within a period of time after the prompt message was displayed.

16. A non-transitory computer-readable medium
having stored thereon a computer program which is executable by a computer, the computer program controlling the computer to execute functions of:
determining whether a user wears a wearable electronic device, based on first data obtained by at least one of a proximity sensor or a contact sensor;
detecting an abnormal action of the user by analyzing second data obtained by a motion sensor when it is determined that the user wears the wearable electronic device;
causing a display to display a prompt message when the abnormal action is detected; and
transmitting a notification to another device when an input from the user is not received within a period of time after the prompt message was displayed.
